(19) United States
(12) Patent Application Publication
(10) Pub. No.: US 2010/0245024 A1
(43) Pub. Date: Sep. 30, 2010

(54) PROTECTIVE ELEMENT

(75) Inventors: Yuji Furuuchi, Ishikawa (JP); Toshiaki Araki, Ishikawa (JP); Takahiro Asada, Ishikawa (JP); Taichiro Kajitani, Ishikawa (JP)

Correspondence Address: K&L Gates LLP, P. O. BOX 1135, CHICAGO, IL, 60690, US

(73) Assignee: SONY CHEMICAL & INFORMATION DEVICE CORPORATION, Tokyo (JP)

(21) Appl. No.: 12/665,382

(22) PCT Filed: Jun. 10, 2008
(86) PCT No.: PCT/JP2008/060602

§ 371 Date: May 19, 2010

(30) Foreign Application Priority Data
Jun. 18, 2007 (JP) 2007-159773

(51) Int. Cl. H01H 37/76

(52) U.S. Cl. 337/283; 361/104

(57) ABSTRACT

A protective element is provided that is capable of stopping heat generation of a heat generation resistor after all of fuse elements are surely blown out in a case where the power is distributed from a specific power distribution path. The protective element can be configured to control blowout times of a plurality of respective fuse elements in such a manner that other fuse elements are blown out prior to the blowout of a specific fuse element in a case where the power is distributed from the specific power distribution path connected with the specific fuse element among the plurality of fuse elements.

### CROSS REFERENCE TO RELATED APPLICATIONS

The present application is a National Stage of International Application No. PCT/JP2008/060602 filed on Jun. 10, 2008 and which claims priority to Japanese Patent Application No. 2007-159773 filed on Jun. 18, 2007, the entire contents of which are being incorporated herein by reference.

### BACKGROUND

The present disclosure relates to a protective element cutting off an electric current by blowing out a low-melting-point metal member in case of an extraordinary situation.

A related art protective element has been known to include a heat generation resistor and a low-melting-point metal member (fuse element) layered on a substrate to prevent not only the over-current but also the over-voltage (see, e.g., Japan Patent No. 2790433 and Japan Patent No. 3067011). In each of the related art protective elements disclosed in Japan Patent No. 2790433 and Japan Patent No. 3067011, the electric power is distributed to the heat generation resistor in case of an extraordinary situation, so that the heat generation resistor generates the heat to melt the fuse element. The melted fuse element is attracted on an electrode in the protective element by good wettability with respect to an electrode surface on which the melted fuse element is placed. Consequently, each of such related art protective elements allows the fuse element to be blown out, thereby cutting off the electric current.

Japan Patent No. 2790433

Japan Patent No. 3067011

Such related art protective elements, however, have a certain probability of not allowing a specific power distribution path to be cut off in a case where a plurality of power distribution paths (a plurality of power inputs) exist with respect to the fuse element, that is, in a case where the power is not distributed from the specific power distribution path in a situation in which all of the power distribution paths are configured to be cut off.

A particular related art protective element is now considered with reference to FIG. 5. The protective element includes three fuse element electrodes 101a, 101b, 101c, two fuse elements 102a, 102b, a heat generation resistor electrode 103, and a heat generation resistor 104 as illustrated in FIG. 5. The two fuse elements 102a, 102b are disposed in such a manner as to lay along the three fuse element electrodes 101a, 101b, 101c, and the heat generation resistor 104 is connected between the heat generation resistor electrode 103 and the fuse element electrode 101b disposed in the middle. Such a protective element includes two power distribution paths from each of the fuse element electrodes 101a, 101c disposed in corresponding side towards the fuse element electrode 101b disposed in the middle. Herein, the protective element allows the power distribution from both of the two power distribution paths as illustrated in an upper portion of FIG. 5. In a case where the heat generation resistor 104 generates the heat, both of the two fuse elements 102a, 102b are blown out as illustrated in a lower portion of FIG. 5. The blowout of the two fuse elements 102a, 102b causes the cutoff of all the power distribution paths, thereby stopping the heat generation of the heat generation resistor 104.

Referring to the related art protective element illustrated in an upper portion of FIG. 6, the power is distributed from one of the power distribution paths, for example, from the fuse element electrode 101a disposed on a left side towards the fuse element electrode 101b disposed in the middle, and the heat generation resistor 104 generates the heat. In a case where the fuse element 102b having no power distribution is blown out first as illustrated on a left side in the middle portion of FIG. 6, the protective element allows the fuse element 102a having the power distribution to be blown out to cut off all of the power distribution paths, thereby stopping the heat generation of the heat generation resistor 104 as illustrated in a lower portion of FIG. 6. In a case where the fuse element 102a having some power distribution is blown out first as illustrated on a right side in the middle portion of FIG. 6, however, the protective element cannot allow the fuse element 102b having no power distribution to be blown out, causing a situation in which not all of the power distribution paths are cut off. Such a situation occurs with the probability of ½ in a case where two fuse elements are disposed in the protective element, or namely, with the probability according to the number of the fuse elements.

For example, such a situation can be observed in a related art protective element 110 mounted to a battery pack, as illustrated in FIG. 7, detachable to an electronic device such as a laptop personal computer. In the battery pack, the power is generally distributed from both the side of a charger for the electronic device and the side of a cell. In a case where the battery pack is removed from the electronic device, however, the charger is not connected to the protective element 110. Consequently, the power is not distributed to the protective element 110 from the side of the charger, causing the situation as illustrated on the right side in the middle portion of FIG. 6.

Therefore, it is desired to provide a protective element capable of stopping heat generation of a heat generation resistor after surely blowing out all of fuse elements in a melting manner in a case where the power is distributed only from a specific power distribution path.

### SUMMARY

The protective element according to another embodiment includes: a heat generation member generating heat by distribution of power thereto; and a plurality of fuse elements, disposed between a plurality of electrodes serving as inputs of power distribution paths, blown out by the heat generated by the heat generation member to cut off an electric current. In a case where the power is distributed from a specific power distribution path connected with a specific fuse element among the plural fuse elements, blowout times of the plural fuse elements are controllable in such a manner that other fuse elements are blown out prior to the specific fuse element.

According to the protective element of the embodiment, the blowout times of the fuse elements can be controlled. In other words, the protective element according to the present invention can specify a fuse element having the longer blowout time among the plural fuse elements. The protective element according to the present invention, therefore, can blow out all of the other fuse elements first in a case where the power is distributed from the power distribution path connected with the specific fuse element having the longer blowout time.

According to the embodiment, in a case where the power is distributed from the power distribution path connected with the specific fuse element having the longer blowout time, all of the other fuse elements can be blown out first. Accordingly, in a case where the power is not distributed from the other power distribution paths, the power distribution to the heat generation member is cut off to stop the heat generation of the heat generation member after the specific fuse element is blown out, that is, after all of the fuse elements are surely blown out. Therefore, the protective element of the present invention can significantly enhance the safety thereof.

Additional features and advantages are described herein, and will be apparent from, the following Detailed Description and the figures.

### BRIEF DESCRIPTION OF THE FIGURES

FIG. 1 is a plan view illustrating an internal structure of a protective element according to an embodiment;

FIG. 2 is a cross-sectional view illustrating the internal structure of the protective element according to the embodiment;

FIG. 3 is a schematic diagram illustrating a circuit structure of the protective element according to the embodiment;

FIG. 4 is a plan view illustrating an internal structure of a protective element produced as Example 6;

FIG. 5 is a schematic diagram illustrating a circuit structure of a related art protective element;

FIG. 6 is a schematic diagram illustrating the circuit structure of the related art protective element and illustrating a situation in which the power is distributed from one of power distribution paths; and

FIG. 7 is a schematic diagram illustrating a circuit structure of a battery pack to which the related art protective element is mounted.

### DETAILED DESCRIPTION

An embodiment is now described in detail with reference to drawings.

According to the embodiment, a protective element cuts off an electric current by blowing out a low-melting-point metal member (fuse element) in case of an extraordinary situation. Particularly, the protective element includes a plurality of fuse elements disposed between a plurality of electrodes serving as inputs of power distribution paths formed on a base substrate. The protective element can control a blowout time of each of the fuse elements to stop the heat generation of a heat generation resistor after all of the fuse elements are blown out in a case where the power is distributed from a specific power distribution path.

A description is now given of basics of the protective element according to the embodiment, followed by a detailed description thereof.

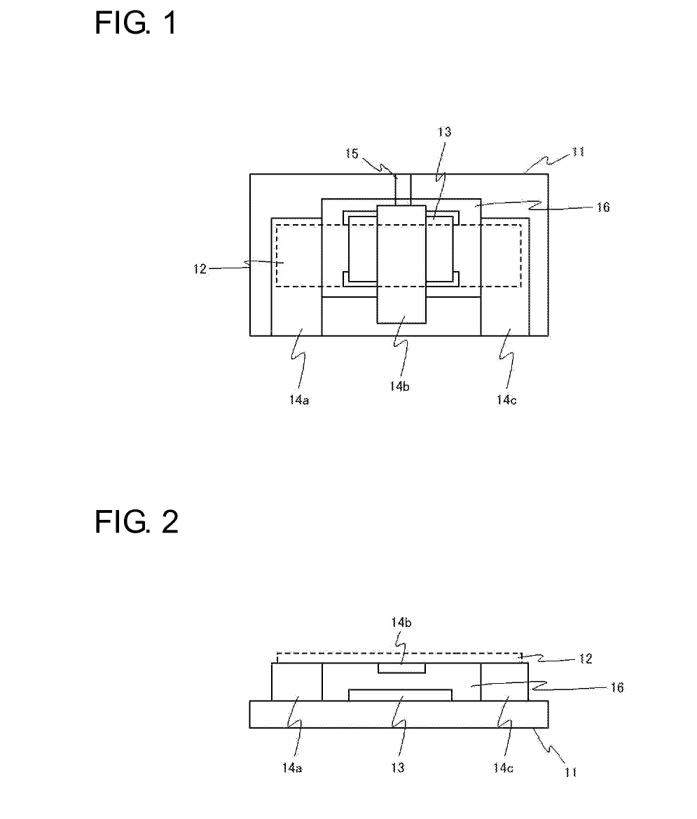

The protective element includes a fuse element 12 and a heat generation resistor (heater) 13 disposed adjacent to each other on a base substrate 11 having a prescribed size as illustrated in a plan view of FIG. 1 and a cross-sectional view of FIG. 2. The fuse element 12 is blown out to cut off an electric current. The heat generation resistor 13 generates the heat to melt the fuse element 12 in case of an extraordinary situation.

The base substrate 11 can be made of any material having an insulation property. The base substrate 11, for example, can be made of a glass substrate, a resin substrate, an insulating metal substrate, and the like in addition to a substrate used for a printed circuit board such as a ceramic substrate and a glass epoxy substrate. Among these substrates, the ceramic substrate serving as an insulation substrate is preferred based on a good thermal resistance and a good thermal conductivity thereof.

The fuse element 12 can be made of various low-melting-point members which have been conventionally used as fuse materials. The fuse element 12, for example, can be made of alloy stated in TABLE 1 in Patent Document of Japan Patent No. 3067011. Particularly, the fuse element 12 can be made of the low-melting-point members such as SnSb alloy, BiSnPb alloy, BiPbSn alloy, BiPb alloy, BiSn alloy, SnPb alloy, SnAg alloy, PbIn alloy, ZnAl alloy, InSn alloy, and PbAgSn alloy. The fuse element 12 can have a shape of flake or stick.

The heat generation resistor 13 is, for example, formed by applying the resistance paste to a conductive material made of ruthenium oxide or carbon-black and the like, and firing such the conductive material applied with the resistance paste as may be necessary. Herein, the resistance paste is, for example, an inorganic binder such as liquid glass or an organic binder such as thermosetting resin and the like. The heat generation resistor 13 can be formed of a thin film, made of the ruthenium oxide or carbon-black, formed through printing, plating, evaporating, and sputtering processes. The heat generation resistor 13 can also be formed by attachment or lamination of such thin films.

In the protective element, the base substrate 11 has a surface including three fuse element electrodes 14a, 14b, 14c electrically connected with the fuse element 12, and a heat generation resistor electrode 15 electrically connected with the heat generation resistor 13 provided thereon. Each of the fuse element electrodes 14a, 14b, 14c and the heat generation resistor electrode 15 is disposed in such a manner as to be insulated from the heat generation resistor 13 through an insulation film 16.

Each of the fuse element electrodes 14a, 14b, 14c, serving as an electrode, is into which the fuse element 12 melted to be flown. A material for the fuse element electrodes 14a, 14b, 14c is not particularly limited, and the fuse elements 14a, 14b, 14c can be made of metal having good wettability with the fuse element 12 being in a melting state. The fuse elements 14a, 14b, 14c, for example, can be made of simple metal such as copper and the like, or can be made of a material having a surface made of at least Ag, Ag—Pt, Ag—Pd, and Au, and the like.

According to the embodiment, the wettability between the fuse element 12 and the fuse element electrodes 14a, 14b, 14c can be changed to control a blowout time of the fuse element 12. Such a change will be described later.

The heat generation resistor electrode 15, on the other hand, does not necessarily consider the wettability with respect to the fuse element 12 being in the melting state. However, since the heat generation resistor electrode 15 is usually formed with the fuse element electrodes 14a, 14b, 14c in a collective manner, the heat generation resistor electrode 15 can be made of a material substantially similar to the fuse element electrodes 14a, 14b, 14c.

Each of the fuse element electrodes 14a, 14b, 14c and the heat generation resistor electrode 15 is connected with a lead (not shown) serving as an external terminal. The lead is made of a metal wire, for example, a flat process wire or a round wire. The lead is attached to each of the fuse element electrodes 14a, 14b, 14c and the heat generation resistor electrode 15 by soldering or welding, thereby being electrically connected to each of the electrodes. In a case where such a lead is employed in the protective element, the lead can be positioned symmetrically, so that serious attention is not necessarily paid to an alignment of an attachment during the attachment process.

Moreover, a sealing member (not shown) made of flux and the like can be disposed above the fuse element 12 to reduce the likelihood of or prevent surface oxide of the fuse element 12. The flux can be any publicly known flux such as rosin flux and the like, and can optionally have the viscosity and the like.

In a case where the protective element is manufactured as a chip component, the protective element is, for example, covered with a cap member made of nylon 4, 6 or liquid crystal polymer and the like, and is provided.

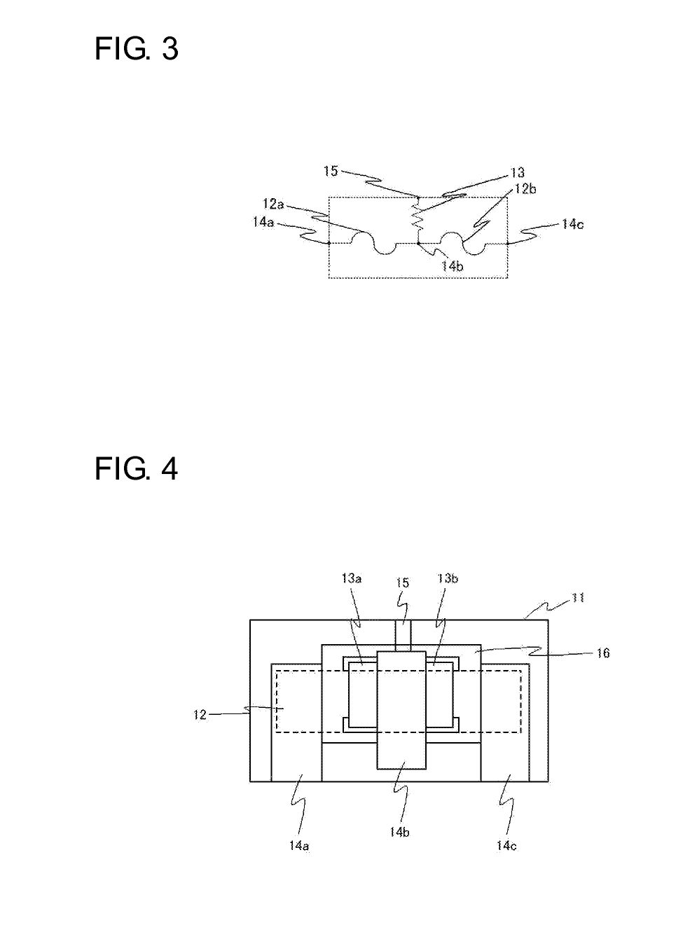

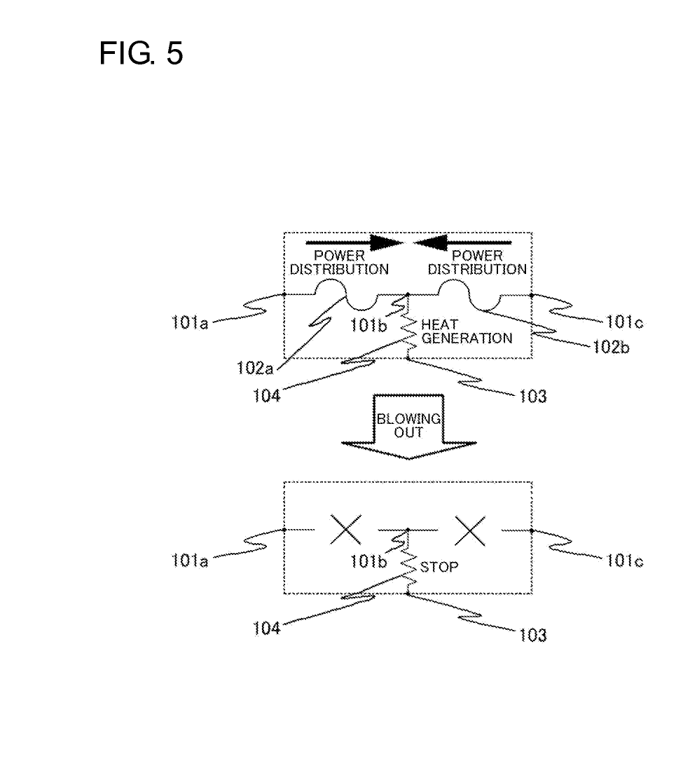

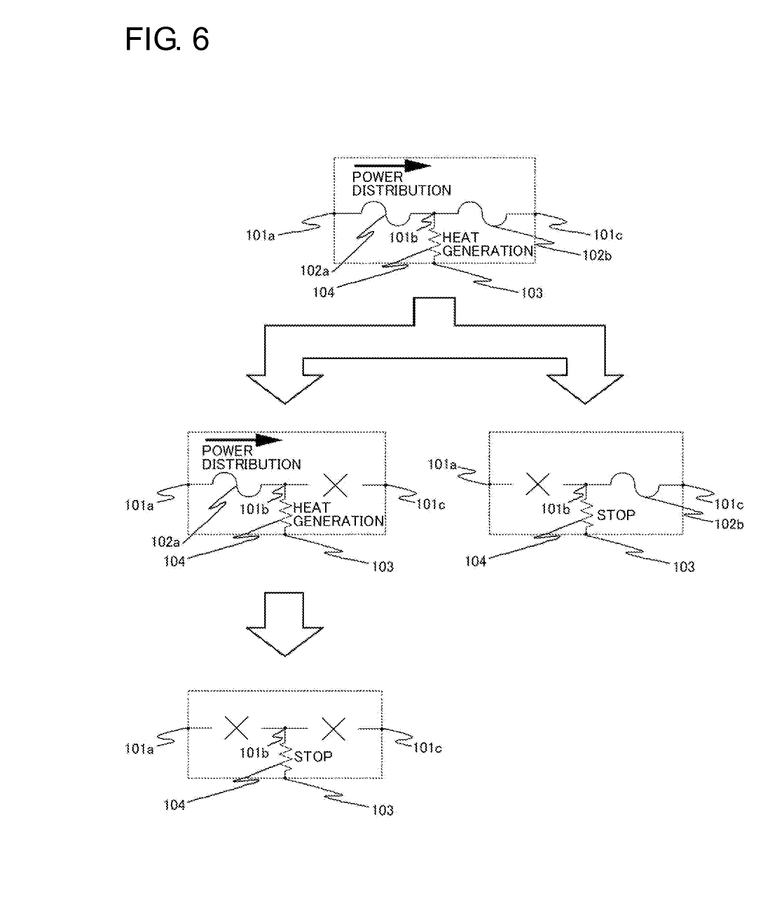

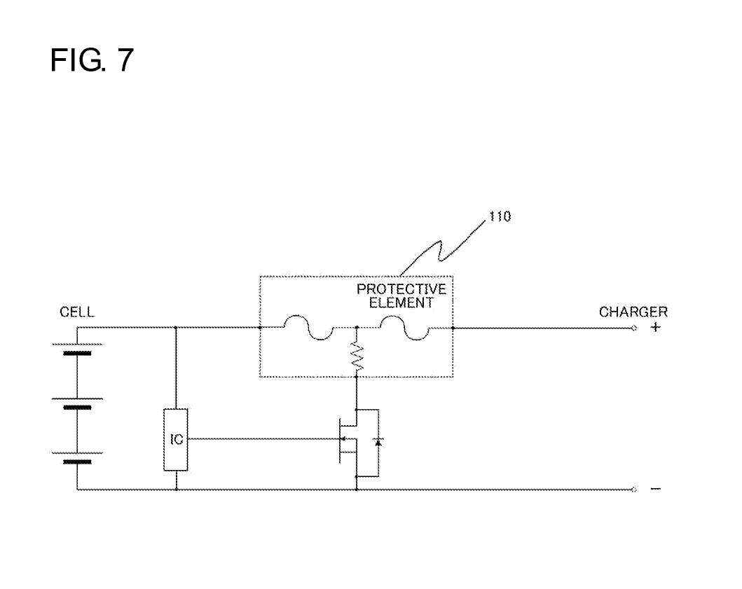

Referring to FIG. 3, a circuit structure of such a protective element is illustrated. In the protective element as illustrated in FIG. 3, two fuse elements 12a, 12b formed of low-melting-point members are disposed in such a manner as to lay along the three fuse element electrodes 14a, 14b, 14c, and the heat generation resistor 13 is connected between the heat generation resistor electrode 15 and the fuse element electrode 14 being in the middle. That is, the protective element includes two power distribution paths from the fuse element electrodes 14a, 14c on respective sides towards the fuse element electrode 14b in the middle, and the power can be distributed from at least one of the fuse elements 14a, 14c towards the fuse element electrode 14b.

In a case where the power is distributed from both of the power distribution paths, and the heat generation resistor 13 generates the heat in the protective element, the fuse element 12a between the fuse element electrodes 14a, 14b and the fuse element 12b disposed between the fuse element electrodes 14b, 14c are blown out, thereby cutting off the power distribution to the heat generation resistor 13 and a device to be protected.

According to the embodiment, in a case where the power is distributed from a specific power distribution path among the two power distribution paths in the protective element, the blowout times of the respective fuse elements 12a, 12b are controlled to stop the heat generation of the heat generation resistor 13 after all of the fuse elements 12a, 12b are blown out. Particularly, the protective element can be configured to specify “the fuse element to be surely blown out last.” Accordingly, the protective element allows all of other fuse elements to be blown out first in a case where the power is distributed from at least the power distribution path connected with the specific fuse element.

Herein, the blowout times of the respective fuse elements 12a, 12b can be controlled by making a difference in characteristics of the fuse elements 12a, 12b one from another, changing a characteristic of the heat generation resistor 13 acting on the fuse elements 12a, 12b, or changing characteristics of the fuse element electrodes 14a, 14b, 14c into which the fuse elements 12a, 12b to be flown in case of melting. Particularly, the blowout times of the respective fuse elements 12a, 12b can be controlled mainly by any of following six methods or a combination thereof.

According to the first method, each of the fuse elements 12a, 12b can have a different physical shape such as a cross-sectional area (width and/or thickness). For example, the cross-sectional area of the fuse element 12a is larger than that of the fuse element 12b in the protective element, so that the blowout time of the fuse element 12a can be longer than that of the fuse element 12b. Moreover, the fuse elements 12a, 12b have different shapes in the protective element, so that the blowout times of the respective fuse elements 12a, 12b can differ from each other.

According to the second method, the distance from each of the fuse elements 12a, 12b to the heat generation resistor 13 can differ from each other. For example, a distance from the fuse element 12a to the heat generation resistor 13 is longer than that from the fuse element 12b to the heat generation resistor 13, so that the blowout time of the fuse element 12a can be longer than that of the fuse element 12b. The distance from each of the fuse elements 12a, 12b to the heat generation resistor 13 not only indicates a distance on a plane surface, but also a distance of a three dimensional space such as a distance in a thickness direction of the insulation film 16 serving as a heat transfer path using the heat generation resistor 13 as a heat source. In the protective element, for example, the thickness of the insulation film 16 between the fuse element electrodes 14a, 14b and the thickness of the insulation film 16 between the fuse element electrodes 14b, 14b are changed, so that the distance from each of the fuse elements 12a, 12b to the heat generation resistor 13 can differ from each other. Moreover, one of the fuse elements 12a, 12b is, for example, formed in a shape in such a manner as to float from the insulation film 16, so that the distance from each of the fuse elements 12a, 12b to the heat generation resistor 13 can differ from each other.

Moreover, the third method can differentiate the wettability between each of the fuse elements 12a, 12b and the fuse element electrodes 14a, 14b, 14c into which the fuse elements 12a, 12b are flown in case of melting. In the protective element, for example, the wettability between the fuse element 12a and the fuse element electrodes 14a, 14b into which the fuse element 12a is flown in case of melting is lower than that between the fuse element 12b and the fuse element electrodes 14b, 14c in which the fuse element 12b is flown in case of melting, so that the blowout time of the fuse element 12a can be longer than that of the fuse element 12b. The wettability can be changed by adjusting the metal composition of the fuse element electrodes 14a, 14b, 14c. The wettability can also be changed by adjusting the metal composition of the elements 12a, 12b.

Moreover, the fourth method can differentiate a thermal property such as heat capacity, heat conductivity, or heat-releasing property of a portion adjacent to each of the fuse elements 12a, 12b or the heat generation resistor 13. In the protective element, for example, the heat capacity in the position adjacent to the fuse element 12b is smaller than that in the position adjacent to the fuse element 12a, so that the blowout time of the fuse element 12a can be longer than that of the fuse element 12b. Such a heat characteristic can be changed by, for example, connecting a metal member such as a copper ingot to the position adjacent to one of the fuse element electrodes of the fuse elements 12a, 12b, providing a metal layer in a part of inner layers of the base substrate 11, or mixing a large amount of a glass material and the like in a part of the base substrate 11.

According to the fifth method, each of the fuse elements 12a, 12b can have a different melting point. In the protective element, for example, a low-melting-point metal member is selected in such a manner that a melting point of the fuse element 12a is higher than that of the fuse element 12b, so that the blowout time of the fuse element 12a can be longer than that of the fuse element 12b.

According to the sixth method, a plurality of the heat generation resistors can be disposed, and each of the heat generation resistors can have a different heat generation amount. In the protective element, for example, the heat generation resistor is selected in such a manner that a heat generation amount of the heat generation resistor disposed in a position adjacent to the fuse element 12b is greater than that of the heat generation resistor disposed in a position adjacent to the fuse element 12a, so that the blowout time of the fuse element 12a can be longer than that of the fuse element 12a. The heat generation amount of the heat generation resistor can be changed by adjusting a resistance value of the heat generation resistor.

Therefore, the blowout times of the respective fuse elements 12a, 12b in the protective element can be controlled by any of the six methods or the combination thereof. In other words, the protective element can be configured to specify the fuse element having the longer blowout time among the two fuse elements 12a, 12b. That is, the protective element can be configured to specify “the fuse element to be surely blown out last.” In the protective element, accordingly, in a case where the power is distributed from the power distribution path connected with at least “the fuse element to be surely blown out last,” all of other fuse elements can be blown out first. Therefore, in a case where the power is distributed from the power distribution path connected with at least “the fuse element to be surely blown out last,” the blowout of “the fuse element to be surely blown out last” indicates that that all of the power distribution paths are cut off.

Therefore, “the fuse element to be surely blown out last” is connected to the specific fuse element electrode serving as an input of a “power distribution path on the side surely having the power distribution,” so that the protective element allows the power distribution to the heat generation resistor 13 to be cut off to stop the heat generation after “the fuse element to be surely blown out last” is blown out, that is, after all of the fuse elements 12a, 12b are surely blown out, in a case where the power is not distributed from other power distribution paths. Accordingly, the protective element can significantly enhance the safety thereof. Particularly, the combination of the above plural methods is applied to the protective element instead of an individual application of the above six methods, so that the blowout times of the respective fuse elements 12a, 12b can be flexibly controlled, thereby enhancing the effectiveness and safety of the protective element.

Such a protective element is preferably mounted to a battery pack detachable to an electronic device, for example, a laptop personal computer. That is, the battery pack has a cell side corresponding to “the power distribution path on the side surely having the power distribution.” In the battery pack, “the fuse element to be surely blown out last” is connected to the cell side, so that all of the fuse elements can be surely blown out in the course of operation even in a case where the power is not distributed from a charger side by removing the battery pack from the electronic device. Accordingly, the protective element mounted to the battery pack can significantly enhance the safety thereof.

According to the above embodiment, situations of the respective two fuse elements 12a, 12b are described. Similarly, the present embodiment can be applied to a situation in which three or more fuse elements are disposed.

### EXAMPLE

The protective element serving as a comparative example is in accordance with the structure illustrated in FIG. 1 through FIG. 3. The protective elements serving as Example 1 through Example 6 in accordance with the respective first method through sixth method described above are formed by changing the structure of the protective element serving as the comparative example. In a following description, like components are given the same reference numerals as the embodiment described above for the sake of simplicity.

### Comparative Example

A base substrate 11 was formed of an alumina ceramics substrate having a width of 3 mm, a length of 5 mm, and a thickness of 0.5 mm, and fuse elements 12a, 12b, a heat generation resistor 13, fuse element electrodes 14a, 14b, 14c, a heat generation resistance electrode 15, and an insulation film 16 were provided on the base substrate 11.

Each of the fuse elements 12a, 12b was formed of a low-melting-point metal foil, made of SnSb alloy (Sn:Sb=95:5, liquid phase point of 240° C.), having a width of 1 mm, a length of 4 mm, and a thickness of 0.1 mm. The heat generation resistor 13 was formed by printing the ruthenium oxide-based heat generation resistance paste (DP1900 available from DuPont) on the base substrate 11 and firing for thirty minutes at 850° C. The heat generation resistor 13 had a pattern resistance value of 5 Ω.

Each of the fuse element electrodes 14a, 14b, 14c was formed by printing Ag—Pt paste (5164N available from DuPont) on the base substrate 11 and firing for thirty minutes at 850° C. The heat generation resistor electrode 15 was formed by printing Ag—Pd paste (6177T available from DuPont) on the base substrate 11 and firing for thirty minutes at 850° C. The insulation film 16 was formed by printing glass type inorganic paste on the base substrate 11.

Accordingly, ten (10) protective elements serve as comparative examples, allowed the power distribution only from the side of the fuse element electrode 14a in each of the ten (10) protective elements, and observed the presence or absence of the blowout of the fuse elements 12a, 12b in each of the ten (10) protective elements. As a result, the fuse element 12a disposed between the fuse element electrodes 14a, 14b was blown out before the fuse element 12b disposed between the fuse element electrodes 14b, 14c was blown out, and the power distribution (heat generation of the heat generation resistor 13) was stopped without blowing out the fuse element 12b (in a state in which the fuse element 12b was not yet blown out) in each of the five (5) protective elements among the ten (10) protective elements. That is, the protective elements serving as the comparative examples resulted in that the fuse element 12b having no distribution of the power remained unblown (in a not yet blown out state) with the probability of 50 percent. Consequently, not all of the power distribution paths were cut off.

### Example 1

According to Example 1, a protective element was produced by making a difference in a cross-sectional area of each of the fuse elements 12a, 12b based on the first method described above. That is, the fuse element 12b disposed between the fuse element electrodes 14b, 14c was formed with a width of 0.7 mm while the fuse element 12a disposed between the fuse element electrodes 14a, 14b was formed with a width of 1 mm, so that the protective element of Example 1 was produced. Other structures of the protective element of Example 1 were substantially similar to those of the comparative example.

Ten (10) protective elements serving as Examples 1, allowed the power distribution only from the side of the fuse element electrode 14a in each of the ten (10) protective elements, and observed the presence or absence of the blowout of the fuse elements 12a, 12b in each of the ten (10) protective elements. As a result, the fuse element 12b disposed between the fuse element electrodes 14b, 14c was blown out first, then the fuse element 12a disposed between the fuse element electrodes 14a, 14b was blown out, and the power distribution was stopped in all of the ten (10) protective elements evaluated. Meanwhile, additional ten (10) protective elements serving as supplement Examples 1 were produced. The fuse element 12b disposed between the fuse element electrodes 14b, 14c was formed with a width of 0.8 mm in each of the protective elements serving as the supplement Examples 1, and the power was distributed as similar to the above. The fuse element 12b was unblown (in a not yet blown out state) in each of two (2) protective elements among the ten (10) protective elements serving as the supplement Examples 1. Therefore, Examples 1 confirmed that not only the difference in the cross-sectional area of the fuse elements 12a, 12b was effective, but also the effectiveness could be enhanced with an increase in the difference.

### Example 2

According to Example 2, a protective element was produced by making a difference in a distance from each of the fuse elements 12a, 12b to the heat generation resistor 13 based on the second method described above. That is, the heat generation resistor 13 disposed in a substantially middle position in an arrangement direction of the fuse element electrodes 14a, 14b, 14c was shifted to the side of the fuse element electrode 14c by 0.1 mm, so that the protective element of Example 2 was produced. Other structures of the protective element of Example 2 were substantially similar to those of the comparative example.

Accordingly, ten (10) protective elements were produced serving as Examples 2, allowed the power distribution only from the side of the fuse element electrode 14a in each of the ten (10) protective elements, and observed the presence or absence of the blowout of the fuse elements 12a, 12b in each of the ten (10) protective elements. As a result, the fuse element 12b disposed between the fuse element electrodes 14b, 14c was blown out first, then the fuse element 12a disposed between the fuse element electrodes 14a, 14b was blown out, and the power distribution was stopped in all of the ten (10) protective elements evaluated. Meanwhile, additional ten (10) protective elements serving as supplement Examples 2 were produced. The heat generation resistor 13 was shifted by 0.05 mm in each of the protective elements serving as the supplement Examples 2, and the power was distributed as similar to the above. The fuse element 12b was unblown (in a not yet blown out state) in each of three (3) protective elements among the ten (10) protective elements serving as the supplement Examples 2. Therefore, Examples 2 confirmed that not only the difference in distance from each of the fuse elements 12a, 12b to the heat generation resistor 13 was effective, but also the effectiveness could be enhanced with an increase in the difference.

### Example 3

According to Example 3, a protective element was produced by making a difference in the wettability between each of the fuse elements 12a, 12b and the fuse element electrodes 14a, 14b, 14c based on the third method described above. That is, an entire surface region of the fuse element electrode 14c and a half of a surface region of the fuse element electrode 14b on the side of the fuse element electrode 14c were plated with gold, so that the protective element according to Example 3 was produced. Other structures of the protective element of Example 3 were substantially similar to those of the comparative example.

Accordingly, ten (10) protective elements were produced serving as Examples 3, allowed the power distribution only from the side of the fuse element electrode 14a in each of the ten (10) protective elements, and observed the presence or absence of the blowout of the fuse elements 12a, 12b in each of the ten (10) protective elements. As a result, the fuse element 12b disposed between the fuse element electrodes 14b, 14c was blown out first, then the fuse element 12a disposed between the fuse element electrodes 14a, 14b was blown out, and the power distribution was stopped in all of the ten (10) protective elements evaluated. Therefore, Example 3 confirmed that the wettability difference between each of the fuse elements 12a, 12b and the fuse element electrodes 14a, 14b, 14c was effective.

### Example 4

According to Example 4, a protective element was produced by making a difference in a thermal property of a portion adjacent to each of the fuse elements 12a, 12b or the heat generation resistor 13 based on the fourth method described above. That is, a copper ingot having a width of 0.5 mm, a length of 0.5 mm, and a thickness of 0.5 mm was soldered and connected in the vicinity of the fuse element electrode 14a, so that the protective element according to Example 4 was produced. Other structures of the protective element of Example 4 were substantially similar to those of the comparative example.

Accordingly, ten (10) protective elements were produced serving as Examples 4, allowed the power distribution only from the side of the fuse element electrode 14a in each of the ten (10) protective elements, and observed the presence or absence of the blowout of the fuse elements 12a, 12b in each of the ten (10) protective elements. As a result, the fuse element 12b disposed between the fuse element electrodes 14b, 14c was blown out first, then the fuse element 12a disposed between the fuse element electrodes 14a, 14b was blown out, and the power distribution was stopped in all of the ten (10) protective elements evaluated. Therefore, Example 4 confirmed that the difference in the thermal property of the portion adjacent to each of the fuse elements 12a, 12b or the heat generation resistor 13 was effective.

### Example 5

According to Example 5, a protective element was produced by making a difference in a melting point of each of the fuse elements 12a, 12b based on the fifth method described above. The fuse element 12b was made of SnAg alloy (Sn:Ag=96.5:3.5, liquid phase point of 221° C.) and disposed between the fuse element electrodes 14b, 14c, so that the protective element of Example 5 was produced. Other structures of the protective element of Example 5 were substantially similar to those of the comparative example.

Accordingly, ten (10) protective elements were produced serving as Examples 5, allowed the power distribution only from the side of the fuse element electrode 14a in each of the ten (10) protective elements, and observed the presence or absence of the blowout of the fuse elements 12a, 12b in each of the ten (10) protective elements. As a result, the fuse element 12b disposed between the fuse element electrodes 14b, 14c was blown out first, then the fuse element 12a disposed between the fuse element electrodes 14a, 14b was blown out, and the power distribution was stopped in all of the ten (10) protective elements evaluated. Therefore, Example 5 confirmed that the difference in the melting point of each of the fuse elements 12a, 12b was effective.

### Example 6

According to Example 6, a protective element was produced by disposing a plurality of the heat generation resistors and making a difference in a heat generation amount for each of the plural heat generation resistors based on the sixth method described above. That is, the heat generation resistors 13a, 13b having different resistance values were respectively disposed between the fuse element electrodes 14a, 14b and between the fuse element electrodes 14b, 14c in series as illustrated in FIG. 4, so that the protective element according to Example 6 was produced. The heat generation resistor 13a, disposed in a position near the fuse element 12a, had the resistance value of 2 Ω. The heat generation resistor 13b, disposed in a position near the fuse element 12b, had the resistance value of 3 Ω. Other structures of the protective element of Example 6 were substantially similar to those of the comparative example.

Accordingly, ten (10) protective elements were produced serving as Examples 6, allowed the power distribution only from the side of the fuse element electrode 14a with a constant current of 1A in each of the ten (10) protective elements, and observed the presence or absence of the blowout of the fuse elements 12a, 12b in each of the ten (10) protective elements. As a result, the fuse element 12b disposed between the fuse element electrodes 14b, 14c was blown out first, then the fuse element 12a disposed between the fuse element electrodes 14a, 14b was blown out, and the power distribution was stopped in all of the ten (10) protective elements evaluated. Meanwhile, additional ten (10) protective elements serving as supplement Examples 6 were produced. The heat generation resistor 13a disposed between the fuse element electrodes 14a, 14b had the resistance value of 2.5 Ω in each of the protective elements serving as the supplement Examples 6, and the power was distributed as similar to the above. The fuse element 12b was unblown (in a not yet blown out state) in one protective element among the ten (10) protective elements serving as the supplement Examples 6. Therefore, Examples 6 confirmed that not only the disposition of the plural heat generation resistors having different heat generation amounts was effective, but also the effectiveness could be enhanced with an increase in the difference of the heat generation amounts.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-15. (canceled)

16. A protective element comprising:
a heat generation member for generating heat by distribution of power thereto; and
a plurality of fuse elements, disposed between a plurality of electrodes serving as inputs of power distribution paths, capable of being blown out by the heat generated by the heat generation member to cut off an electric current;
wherein when the power is distributed from a specific power distribution path connected with a specific fuse element among the plural fuse elements, blowout times of the respective plural fuse elements are controllable in such a manner that other fuse elements are blown out prior to the specific fuse element.

17. The protective element according to claim 16, wherein a specific electrode connected with the specific fuse element is an electrode serving as an input of a power distribution path having the power distribution among the plural electrodes.

18. The protective element according to claim 16, wherein the plural fuse elements have differences in physical shapes thereof in such a manner that the blowout time of the specific fuse element is longer than that of each the other fuse elements.

19. The protective element according to claim 17, wherein the plural fuse elements have differences in physical shapes thereof in such a manner that the blowout time of the specific fuse element is longer than that of each the other fuse elements.

20. The protective element according to claim 18, wherein the specific fuse element is formed in such a manner that a cross-sectional area thereof is larger than that of each of the other fuse elements.

21. The protective element according to claim 19, wherein the specific fuse element is formed in such a manner that a cross-sectional area thereof is larger than that of each of the other fuse elements.

22. The protective element according to claim 16, wherein distances from each of the plural fuse elements to the heat generation member are different in such a manner that the blowout time of the specific element is longer than that of each of the other fuse elements.

23. The protective element according to claim 17, wherein distances from each of the plural fuse elements to the heat generation member are different in such a manner that the blowout time of the specific element is longer than that of each of the other fuse elements.

24. The protective element according to claim 22, wherein the specific fuse element is disposed in such a manner that a distance from the specific fuse element to the heat generation member is longer than that from each of the other fuse elements to the heat generation member.

25. The protective element according to claim 23, wherein the specific fuse element is disposed in such a manner that a distance from the specific fuse element to the heat generation member is longer than that from each of the other fuse elements to the heat generation member.

26. The protective element according to claim 16, wherein wettability between the plural fuse elements and the respective plural electrodes are different in such a manner that the blowout time of the specific fuse element is longer than that of each of the other fuse elements.

27. The protective element according to claim 17, wherein wettability between the plural fuse elements and the respective plural electrodes are different in such a manner that the blowout time of the specific fuse element is longer than that of each of the other fuse elements.

28. The protective element according to claim 26, wherein metal compositions of the plural fuse elements or the plural electrodes or both of the plural elements and the plural electrodes are adjusted in such a manner that the wettability between the specific fuse element and a specific electrode into which the specific fuse element is flown in case of melting is lower than that between the other fuse elements and the respective electrodes into which the other fuse elements are flown in case of melting.

29. The protective element according to claim 27, wherein metal compositions of the plural fuse elements or the plural electrodes or both of the plural elements and the plural electrodes are adjusted in such a manner that the wettability between the specific fuse element and a specific electrode into which the specific fuse element is flown in case of melting is lower than that between the other fuse elements and the respective electrodes into which the other fuse elements are flown in case of melting.

30. The protective element according to claim 16, wherein a portion adjacent to each of the plural fuse elements or the heat generation member has a different thermal property in such a manner that the blowout time of the specific fuse element is longer than that of each of the other fuse elements.

31. The protective element according to claim 17, wherein a portion adjacent to each of the plural fuse elements or the heat generation member has a different thermal property in such a manner that the blowout time of the specific fuse element is longer than that of each of the other fuse elements.

32. The protective element according to claim 29, wherein a portion adjacent to each of the plural fuse elements or the heat generation member has a different thermal property in such a manner that the blowout time of the specific fuse element is longer than that of each of the other fuse elements.

33. The protective element according to claim 30, wherein the thermal property is heat capacity, heat conductivity, or heat-releasing property of the portion adjacent to each of the plural fuse elements or the heat generation member.

34. The protective element according to claim 16, wherein each of the plural fuse elements has a different melting point in such a manner that the blowout time of the specific fuse element is longer than that of each of the other fuse elements.

35. The protective element according to claim 17, wherein each of the plural fuse elements has a different melting point in such a manner that the blowout time of the specific fuse element is longer than that of each of the other fuse elements.

36. The protective element according to claim 34, wherein the melting point of the specific fuse element is higher than that of each of the other fuse elements.

37. The protective element according to claim 35, wherein the melting point of the specific fuse element is higher than that of each of the other fuse elements.

38. The protective element according to claim 16, wherein a plurality of the heat generation members are disposed, and
wherein each of the plural heat generation members has a different heat generation amount.

39. The protective element according to claim 17, wherein a plurality of the heat generation members are disposed, and
wherein each of the plural heat generation members has a different heat generation amount.

40. The protective element according to claim 38, wherein a resistance value of a specific heat generation resistor disposed in a position near the specific fuse element is smaller than that of each of the other heat generation resistors disposed near the other fuse elements.

41. The protective element according to claim 39, wherein a resistance value of a specific heat generation resistor disposed in a position near the specific fuse element is smaller than that of each of the other heat generation resistors disposed near the other fuse elements.

42. The protective element according to claim 16, wherein the protective element is mounted to a battery pack detachable to an electronic device, and
wherein the fuse element is connected to a cell side of the battery pack.
